(19) United States
(12) Patent Application Publication
(10) Pub. No.: US 2012/0165039 A1
(43) Pub. Date: Jun. 28, 2012

(54) ELECTRONIC APPARATUS

(75) Inventor: Atsushi SHONO, Ome-shi (JP)

(73) Assignee: KABUSHIKI KAISHA TOSHIBA, Tokyo (JP)

(21) Appl. No.: 13/251,024

(22) Filed: Sep. 30, 2011

(30) Foreign Application Priority Data
Dec. 22, 2010 (JP) 2010-286280

(51) Int. Cl. H04W 24/00

(52) U.S. Cl. 455/456.1

(57) ABSTRACT

According to one embodiment, an electronic apparatus includes a wireless communication module, a select information generation module, a position detection module, and a select module. The wireless communication module executes wireless communication by wireless communication systems. The select information generation module generates a plurality of pieces of communication system select information indicating a pair of a position and a wireless communication system. The position detection module detects a present position. The select module selects a first system indicated by first information corresponding to the present position if the plurality of pieces of communication system select information comprises the first information, and selects a second system of the wireless communication systems selected by a user if the plurality of pieces of communication system select information do not comprise the first information. The select information generation module adds new communication system select information indicating the present position and the second system.

### CROSS-REFERENCE TO RELATED APPLICATIONS

This application is based upon and claims the benefit of priority from prior Japanese Patent Application No. 2010-286280, filed Dec. 22, 2010, the entire contents of which are incorporated herein by reference.

### FIELD

Embodiments described herein relate generally to an electronic apparatus with a wireless communication function.

### BACKGROUND

In recent years, electronic apparatuses with a wireless communication function, such as a mobile phone, a smartphone and a slate PC (tablet PC), have been gaining in popularity. Some of such electronic apparatuses can execute communication by a plurality of wireless communication systems. For example, use has been made of a smartphone having a communication function by the third generation mobile communication system (3G communication system), a wireless local area network (wireless LAN) communication function and a Bluetooth (trademark) communication function. A user uses, for example, the wireless LAN communication for download of video data, the 3G communication for transmission/reception of e-mails, and the Bluetooth communication for transmission/reception of data with peripheral devices.

When a mobile communication terminal establishes a connection for wireless communication while moving (“handover”) between a plurality of base stations, the mobile communication terminal selects a base station for connection. The base station is selected, for example, based on the intensity of electrical field which is emitted by each base station. Thereby, the mobile communication terminal can establish a connection to a proper base station based on the intensity of electrical field.

In the meantime, when communication is enabled by a plurality of wireless communication systems, the user selects a wireless communication system, taking into account not only the intensity of electrical field, but also a communication fee and a communication speed. For example, when an access point of a public wireless LAN has been found while the 3G communication is being executed by using a smartphone, the user utilizes the wireless LAN communication by establishing a connection to this access point. Thereby, the user can communicate at a higher speed and a lower cost than the 3G communication, the fee for which is charged at a metered rate. Accordingly, for example, in accordance with the movement of the position, the user selects a wireless communication system which is proper to the place.

However, it is very time-consuming for the user to perform an operation for switching the wireless communication system each time the user moves the position. For example, despite the user passing through a fixed route everyday for commutation, the user has to perform an operation for selecting the same wireless communication system at the same place.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is an exemplary block diagram showing a system configuration of the electronic apparatus of the embodiment.

FIG. 3 is an exemplary conceptual diagram showing the structure for selecting a wireless communication system by the electronic apparatus of the embodiment.

FIG. 4 is an exemplary conceptual diagram showing the structure for learning a wireless communication system by the electronic apparatus of the embodiment.

FIG. 5 shows an example of the correspondence between a position and a wireless communication system, which is learnt by the electronic apparatus of the embodiment.

FIG. 6 is an exemplary block diagram showing an example of the functional structure of a communication system control program which is executed by the electronic apparatus of the embodiment.

FIG. 7 shows an example of communication system select information which is used by the communication system control program which is executed by the electronic apparatus of the embodiment.

FIG. 8 shows an example of position information which is used by the communication system control program which is executed by the electronic apparatus of the embodiment.

FIG. 9 shows an example of a communication system select screen which is displayed by the electronic apparatus of the embodiment.

FIG. 10 shows an example of an access point select screen which is displayed by the electronic apparatus of the embodiment.

FIG. 11 is an exemplary flowchart illustrating an example of the procedure of a communication system switching process which is executed by the electronic apparatus of the embodiment.

FIG. 12 is an exemplary flowchart illustrating a communication system select process which is executed by the electronic apparatus of the embodiment.

### DETAILED DESCRIPTION

Various embodiments will be described hereinafter with reference to the accompanying drawings.

In general, according to one embodiment, an electronic apparatus includes a wireless communication module, a select information generation module, a position detection module, and a select module. The wireless communication module executes wireless communication by a plurality of wireless communication systems. The select information generation module generates a plurality of pieces of communication system select information indicative of a pair of a position and a wireless communication system of the plurality of wireless communication systems, the wireless communication system being associated with the position. The position detection module detects a present position of the electronic apparatus. The select module selects a first wireless communication system indicated by first communication system select information corresponding to the present position if the plurality of pieces of communication system select information comprise the first communication system select information, and selects a second wireless communication system of the plurality of wireless communication systems if the plurality of pieces of communication system select information do not comprise the first communication system select information, the second wireless communication system being selected by a user. The select information generation module adds new communication system select information to the plurality of pieces of communication system select information, the new communication system information indicating the present position and the second wireless communication system.

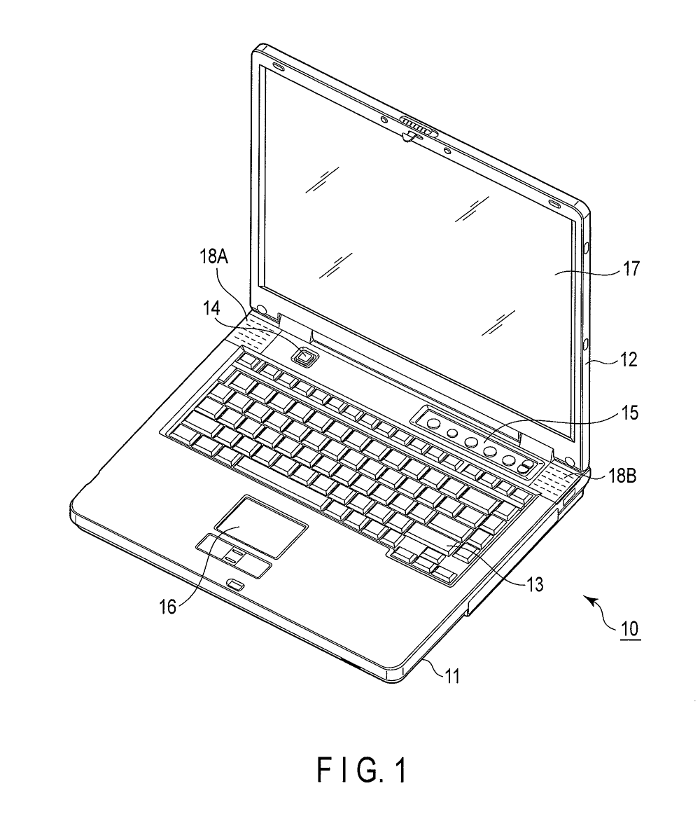

FIG. 1 is a perspective view showing the external appearance of an electronic apparatus according to an embodiment. This electronic apparatus is realized, for example, as a notebook-type personal computer 10. In addition, this electronic apparatus may be realized, for example, as a mobile phone, a smartphone, a PDA, or a slate PC (tablet PC). As shown in FIG. 1, the computer 10 includes a computer main body 11 and a display unit 12. A liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touch pad 16, and speakers 18A and 18B are disposed on the top surface of the housing of the computer main body 11. Various operation buttons are provided on the input operation panel 15.

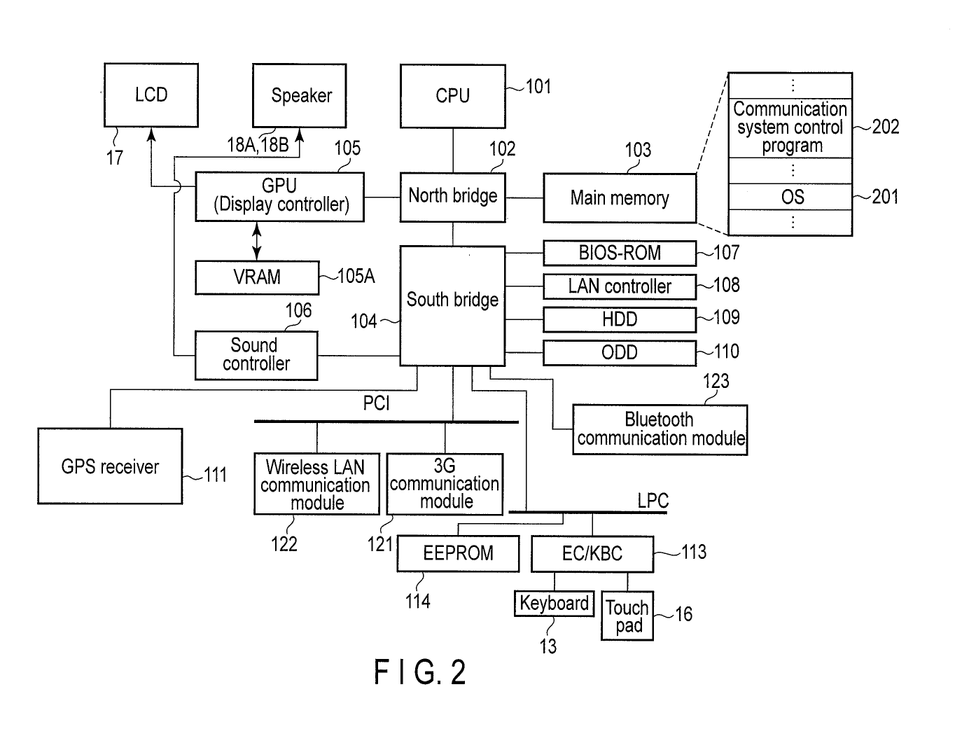

FIG. 2 shows the system configuration of the computer 10.

The computer 10, as shown in FIG. 2, includes a central processing unit (CPU) 101, a north bridge 102, a main memory 103, a south bridge 104, a graphics processing unit (GPU) 105, a video random access memory (VRAM) 105A, a sound controller 106, a basic input/output system-read only memory (BIOS-ROM) 107, a local area network (LAN) controller 108, a hard disk drive (HDD) 109, an optical disc drive (ODD) 110, a GPS receiver 111, an embedded controller/keyboard controller (EC/KBC) 113, an EEPROM (electrically erasable programmable ROM) 114, a 3G communication module 121, a wireless LAN communication module 122, and a Bluetooth communication module 123.

The CPU 101 is a processor for controlling the operation of the respective components of the computer 10. The CPU 101 executes an operating system (OS) 201, a communication system control program 202 and various application programs, which are loaded from the HDD 109 into the main memory 103. The communication system control program 202 is software for controlling wireless communication by a plurality of wireless communication systems, which is executed by the computer 10. The communication system control program 202 controls the wireless communication so that the wireless communication may be executed by one of the wireless communication systems. For example, the communication system control program 202 executes wireless communication by a wireless communication system which is associated with the present position by using position information indicative of the present position of the computer 10 and communication system select information stored in the HDD 109. The position information is detected, for example, by using GPS data which is received by the GPS receiver 111. The communication system select information stored in the HDD 109 is indicative of, for example, a position (communication place) and a wireless communication system which is associated with this position.

Besides, the CPU 101 executes a BIOS which is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the GPU 105 via, e.g. a PCI EXPRESS serial bus.

The GPU 105 is a display controller which controls the LCD 17 that is used as a display monitor of the computer 10. A display signal, which is generated by the GPU 105, is sent to the LCD 17.

The south bridge 104 controls devices on a Peripheral Component Interconnect (PCI) bus and devices on a Low Pin Count (LPC) bus. The south bridge 104 includes an Integrated Drive Electronics (IDE) controller for controlling the HDD 109 and ODD 110. The south bridge 104 also has a function of communicating with the sound controller 106.

The sound controller 106 is a sound source device and outputs audio data, which is a target of playback, to the speakers 18A and 18B. The LAN controller 108 is a wired communication device which executes wired communication of, e.g. the IEEE 802.3 standard.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

The GPS receiver 111 receives GPS data that is transmitted from a plurality of GPS satellites. The present position, height, etc. of the computer 10 are detected by using the GPS data which is received by the GPS receiver 111.

The computer 10 includes a plurality of wireless communication modules, such as the 3G communication module 121, wireless LAN communication module 122 and Bluetooth communication module 123.

The 3G communication module 121 is a wireless communication device which executes wireless communication by, e.g. the third-generation mobile communication system (wireless communication based on the IMT-2000 standard; also called “3G wireless communication”). The 3G communication module 121 executes communication by establishing a connection to a base station.

The wireless LAN communication module 122 executes wireless communication based on, e.g. the IEEE 802.11a/b/g/n standard (also called “wireless LAN communication”). The wireless LAN communication module 122 executes communication by establishing a connection to an access point.

The Bluetooth communication module 123 executes wireless communication of, e.g. the Bluetooth standard (Bluetooth communication). The Bluetooth communication module 123 executes communication by establishing a connection to, e.g. a communication-target device (a communication module provided in the communication-target device).

The communication system control program 202 selects a wireless communication system from among the 3G communication, wireless LAN communication and Bluetooth communication, for example, based on the present position detected by using the GPS receiver 111. That is, the selected wireless communication system is associated with the present position. In the computer 10, the wireless communication is executed by the selected wireless communication system. The plural wireless communication systems, which are selected by the communication system control program 202, are not limited to the 3G communication, wireless LAN communication and Bluetooth communication. That is, the plural wireless communication systems may include any kind of wireless communication system, such as GSM (trademark), wireless communication (WiMAX communication) based on the IEEE 802.16-2004 standard, wireless communication (mobile WiMAX communication) based on the IEEE 802.16e standard, or TransferJet (trademark) communication. In addition, the wireless communication module (wireless communication device), which is used by the computer 10, may be a so-called combo-module having two wireless communication functions for executing two different wireless communication systems. For example, a single wireless communication device may execute wireless LAN communication and mobile WiMAX communication.

In the meantime, in the wireless LAN communication, there is known a technique. According to this technique, such a case is assumed that a connection between the wireless LAN module 122 and a certain access point is once established, and then this connection is released. In such a case, if the wireless LAN module 122 has entered once again the area in which a connection to this access point is enabled, a connection between the wireless LAN module 122 and the access point is automatically established. In this technique, however, the wireless LAN connection is merely established automatically in the area corresponding to the access point of the wireless LAN. It is not possible to effect switching, at any position, to a selected one of the plural wireless communication systems. For example, in the above technique, it is possible to execute wireless LAN communication in an area corresponding to an access point of wireless LAN, and to execute 3G communication at other areas. However, it is not possible to execute control so as to perform 3G communication in an area where 3G communication, wireless LAN communication and Bluetooth communication are enabled.

According to the communication system control program 202 of the present embodiment, the position of the computer 10 is detected by using the data received by the GPS receiver 111, and communication is executed by a wireless communication system associated with the detected position. Therefore, at any position, switching can be effected to a selected one of the plural wireless communication systems.

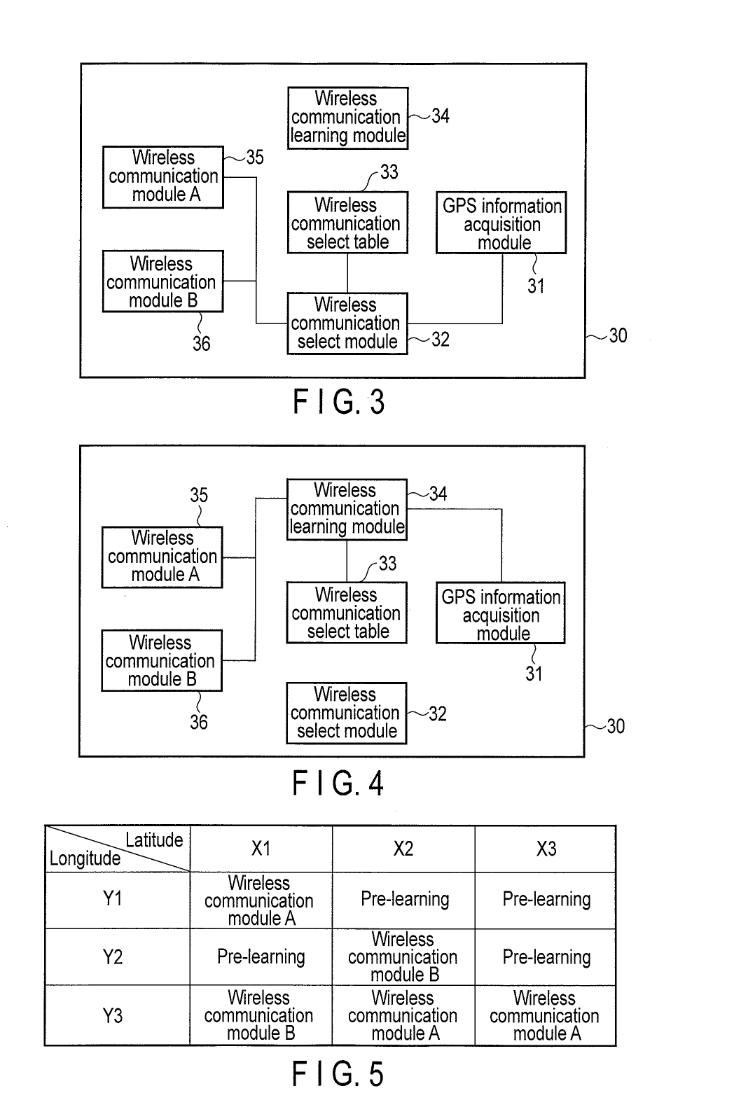

The communication system control program 202 operates in either a communication system switching mode or a communication system learning mode. FIGS. 3 and 4 are conceptual views for explaining these two modes.

FIG. 3 shows an example of the structure in the communication system switching mode. To start with, in the communication system switching mode, a GPS information acquisition module 31 acquires the present position of the computer 10 by using, e.g. data which is received by the GPS receiver 111. Then, a wireless communication select module 32 determines a wireless communication system which is associated with the present position acquired by the GPS information acquisition module 31 by referring to a wireless communication select table 33. The wireless communication select module 32 executes setting so that wireless communication may be executed by that one of a wireless communication module A 35 and a wireless communication module B 36, which corresponds to the determined wireless communication system.

On the other hand, FIG. 4 shows an example of the structure in the communication system learning mode. To start with, in the communication system learning mode, the GPS information acquisition module 31 acquires the present position of the computer 10 by using, e.g. data which is received by the GPS receiver 111. Then, a wireless communication learning module 34 executes setting so that wireless communication may be executed by that one of the wireless communication module A 35 and the wireless communication module B 36, which corresponds to, for example, a wireless communication system which is selected by the user. The wireless communication learning module 34 learns the wireless communication system which is associated with the present position, by storing information in the wireless communication select table 33. The information indicates the present position acquired by the GPS information acquisition module 31 and the wireless communication system selected at the present position.

FIG. 5 is a conceptual view showing an example of the structure of the wireless communication select table 33. The wireless communication select table 33 shows, for example, a position (also referred to as “communication place”) represented by, e.g. a latitude and a longitude, and wireless communication module associated with this position. In the example of the wireless communication select table 33 shown in FIG. 5, “Wireless communication module A”, for instance, is set at a position of (latitude X1, longitude Y1). At a position of (latitude X1, longitude Y3), “Wireless communication module B” is set. At a position of (latitude X1, longitude Y2), “Pre-learning” is set, which indicates that the wireless communication module has not yet been learnt. The place corresponding to the position at which “Pre-learning” is set is, for example, a place at which the user has not yet selected the wireless communication system, or a place which the user has not yet visited.

For example, the user performs an operation of selecting the wireless communication module that is to be used, at a place where the user has first visited. Thereby, the communication system control program 202 adds an entry corresponding to the place (position) to the wireless communication select table 33. When the user revisits the place corresponding to the added entry, the communication system control program 202 effects switching to execute the wireless communication by the wireless communication system which is designated in this entry. In short, the communication system control program 202 can seamlessly switch the wireless communication system in accordance with the present position. The switching of the wireless communication system refers to the switching of a communication system (communication module) which is used in data transmission/reception (communication) by various application programs such as a browser, video streaming software and software for transmitting/receiving e-mails. Thus, even if the communication system is switched, the communication for establishing/releasing a connection to a base station by the 3G communication module 121, the communication for detecting an access point by the wireless LAN communication module 122 and the communication for detecting a connection-target device by the Bluetooth communication module 123 are executed on the background.

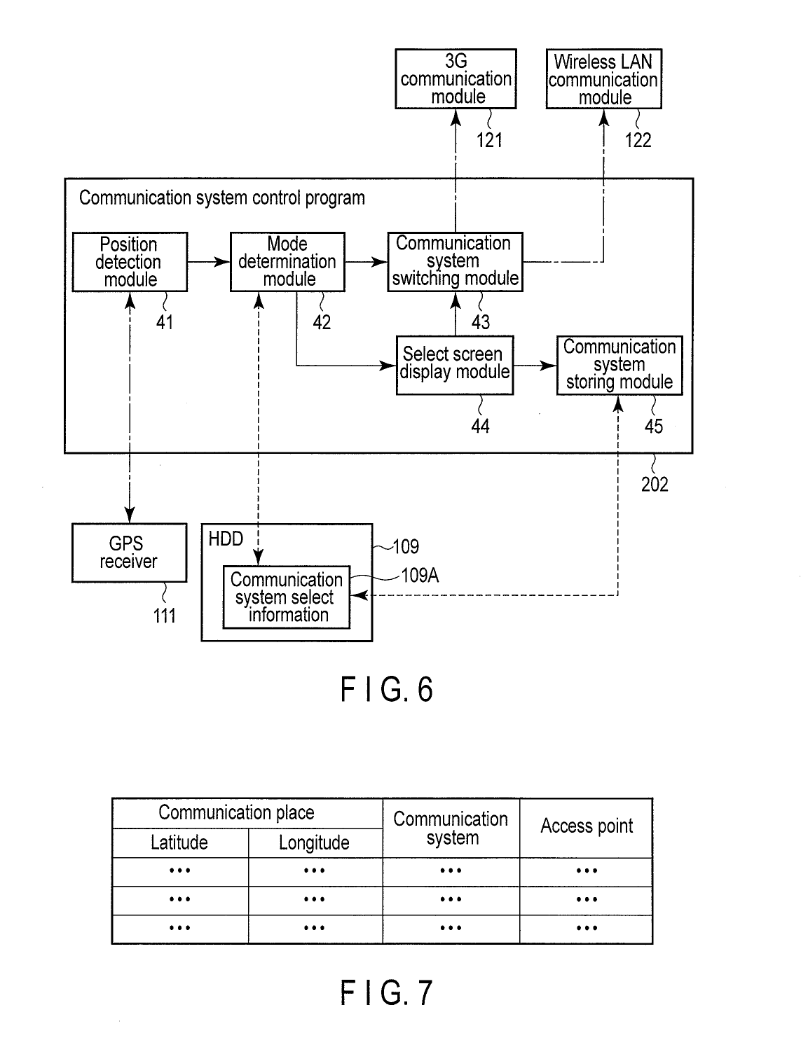

FIG. 6 shows an example of the functional structure of the communication system control program 202 for executing the operations in the above-described communication system switching mode and communication system learning mode. The description below is given of the example in which wireless communication is executed by either the 3G communication or the wireless LAN communication. However, the same operation similarly applies to a case where another wireless communication system, such as Bluetooth communication system, is used, or a case where a greater number of wireless communication systems are used.

The communication system control program 202 includes, for example, a position detection module 41, a mode determination module 42, a communication system switching module 43, a select screen display module 44, and a communication system storing module 45.

The position detection module 41 detects the present position of the computer 10 by using data which is received by the GPS receiver 111. The GPS receiver 111 receives, for example, a plurality of GPS data which are transmitted from a plurality of GPS satellites. The GPS receiver 111 outputs the received plural GPS data to the position detection module 41. Using the plural GPS data output by the GPS receiver 111, the position detection module 41 detects (calculates) the present position of the computer 10. The detected present position is represented by, for example, a latitude and a longitude. The position detection module 41 detects the present position at regular intervals (e.g. every second). The position detection module 41 outputs position information indicative of the detected present position to the mode determination module 42.

The mode determination module 42 whether the communication place (first communication place) corresponding to the present position is already associated with one wireless communication system (first communication system) among a plurality of wireless communication systems based on the position information output by the position detection module 41 and communication system select information 109A stored in the HDD 109. Based on the determination result, the mode determination module 42 then determines either the operation in the communication system switching mode or the operation in the communication system learning mode. Specifically, when the first communication place corresponding to the present position has already been associated with the first communication system, the mode determination module 42 determines the execution of the operation in the communication system switching mode. When the first communication place corresponding to the present position has not yet been associated with a communication system, the mode determination module 42 determines the execution of the operation in the communication system learning mode.

FIG. 7 shows a structure example of the communication system select information 109A which is used by the communication system control program 202. The communication system select information 109A includes a plurality of entries corresponding to a plurality of positions (communication places). To be more specific, the communication system select information 109A includes a plurality of entries indicating a plurality of positions and that one of a plurality of wireless communication systems, which is associated with each of the plurality of positions. Each of the entries includes, for example, a latitude, a longitude, a communication system, and an access point. In the entry corresponding to a certain position, “Latitude” indicates the latitude corresponding to this position. The “Longitude” indicates the longitude corresponding to this position. The “Communication system” indicates the wireless communication system which is associated with this position. The “Access point” indicates the access point name (e.g. SSID) which is associated with this position. In the “Access point”, the access point name is set, for example, when the wireless LAN communication has been associated with this position. Thus, when the 3G communication has been associated with this position, the access point name is not set.

Based on the position information that is output by the position detection module 41, the mode determination module 42 determines whether the entry corresponding to the present position is included in the communication system select information 109A as shown in FIG. 7.

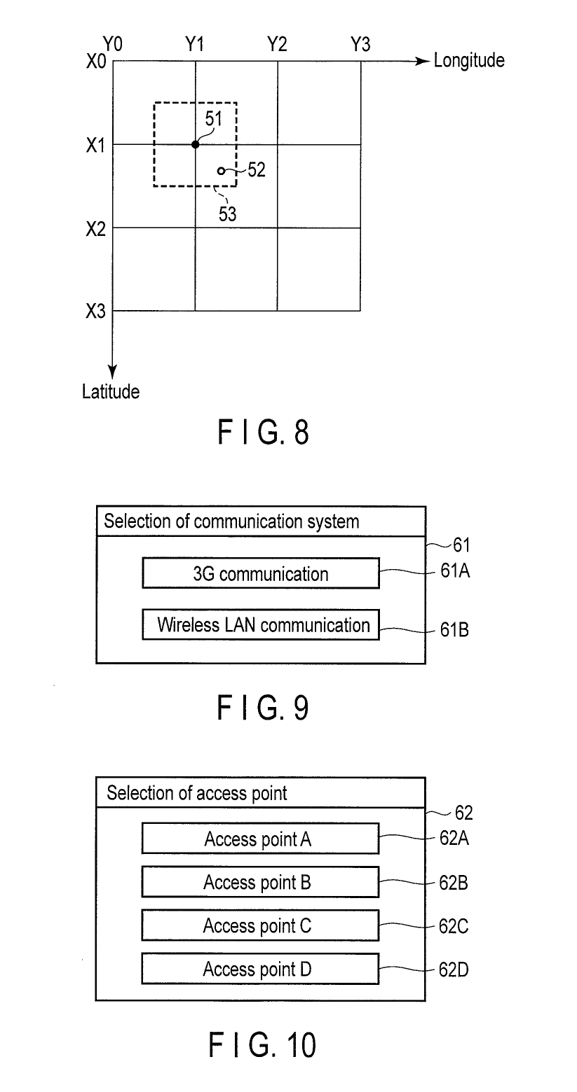

Referring to FIG. 8, a description is given of the relationship between the present position and the positions indicated in the entries of the communication system select information 109A.

The “position” indicated in the communication system select information 109A is expressed by, for example, a representative point which is designated by the latitude and longitude which are divided at every predetermined distance (e.g. 10 meters). In FIG. 8, an intersection of solid lines representing the latitude and longitude which are divided at every predetermined distance (i.e. an apex of each of blocks divided in a gridded shape) is used as the representative point indicative of “position”. For example, a position 51 is a representative point indicated by (latitude X1, longitude Y1).

The mode determination module 42 determines the communication system select information 109A (the entry in the communication system select information 109A) corresponding to the present position by determining the representative point which is closest to the present position detected by the position detection module 41. For example, when a present position 52 has been detected by the position detection module 41, the mode determination module 42 determines the communication system select information 109A corresponding to the representative point 51 (i.e. (latitude X1, longitude Y1)) to be the communication system select information 109A corresponding to the present position. In other words, when the present position 52 is included in an area 53 centering at the representative point 51, the mode determination module 42 determines the communication system select information 109A corresponding to the representative point 51 to be the communication system select information 109A corresponding to the present position. This area 53 is, for example, a rectangle centering at the representative point 51 and having a size corresponding to a predetermined distance. In short, the present position 52 corresponds to the communication place indicated by the area 53.

When the communication system select information 109A includes an entry corresponding to the present position, the mode determination module 42 reads the entry of the communication system select information 109A, which corresponds to the present position, from the HDD 109. Then, the mode determination module 42 determines whether the wireless communication system, which is used at the present position, is designated in the read entry (communication system select information 109A). When the wireless communication system is designated, the mode determination module 42 determines the execution of the operation in the communication system switching mode.

On the other hand, when the wireless communication system, which is used at the present position, is not designated in the read entry, or when the communication system select information 109A does not include an entry corresponding to the present position, the mode determination module 42 determines the execution of the operation in the communication system learning mode. In the meantime, when the communication system select information 109A does not include an entry corresponding to the present position, the mode determination module 42 newly creates (adds) an entry of the communication system select information 109A, which corresponds to the present position.

Next, to begin with, the operations of the respective components in the communication system switching mode are described. In the communication system switching mode, a first communication system, which is associated with a first communication place corresponding to the present position of the computer 10, is selected from a plurality of wireless communication systems. Specifically, when the entry corresponding to the present position is included in the communication system select information 109A, that one of a plurality of wireless communication modules, which corresponds to the wireless communication system indicated in this entry, is selected.

In the communication system switching mode, the mode determination module 42 first outputs the read entry (communication system select information 109A) to the communication system switching module 43.

The communication system switching module 43 switches to the wireless communication system which is designated in the entry of the communication system select information 109A which has been output by the mode determination module 42. Specifically, the communication system switching module 43 selects one of the plural wireless communication modules, which corresponds to the wireless communication system indicated by the entry. To be more specific, when the currently used wireless communication system is the same as the wireless communication system designated in the entry, the communication system switching module 43 does not switch the wireless communication system. For example, when the 3G communication is being executed by using the 3G communication module and the 3G communication is designated in the entry corresponding to the present position, the communication system switching module 43 does not switch the wireless communication system.

On the other hand, when the currently used wireless communication system is different from the wireless communication system designated in the entry, the communication system switching module 43 switches the wireless communication system to the wireless communication system that is designated in the entry. Specifically, the communication system switching module 43 executes setting so that wireless communication may be executed by the communication module corresponding to the wireless communication system designated in the entry (e.g. the 3G communication module 121, wireless LAN communication module 122 or Bluetooth communication module 123). For example, when the wireless communication is being executed by using the 3G communication module and the wireless LAN communication is designated in the entry corresponding to the present position, the communication system switching module 43 executes setting so that the wireless communication may be executed by using the wireless LAN module 122. Specifically, the communication system switching module 43 executes control so that the communication (packet transfer communication), which is requested by the application program such as a browser or a video streaming program, may be executed by the designated wireless communication system.

Next, the operations of the respective components in the communication system learning mode are described. In the communication system learning mode, when the entry corresponding to the present position of the computer 10 is not included in the communication system select information 109A, a new entry, which indicates the present position and one wireless communication system, which is selected by the user from among the plural wireless communication systems, is added to the communication system select information 109A.

In the communication system learning mode, the mode determination module 42 first notifies the select screen display module 44 that a wireless communication system which is used at the present position has not been designated.

Responding to the notification by the mode determination module 42, the select screen display module 44 displays a communication system select screen for selecting the communication system. FIG. 9 shows an example of the communication system select screen 61. The communication system select screen 61 includes a plurality of items which are indicative of a plurality of wireless communication systems that are used in the computer 10. The communication system select screen 61 includes, for example, a “3G communication” button 61A and a “Wireless LAN communication” button 61B. Using the communication system select screen 61, the user selects the button corresponding to the wireless communication system which is to be used at the present position. The user selects the wireless communication system that is to be used, taking into account, e.g. the communication quality, communication speed, communication fee, etc. When the wireless LAN communication is selected as the wireless communication system to be used, the select screen display module 44 may display an access point select screen for selecting an access point which is to be used for the wireless LAN communication.

FIG. 10 shows an example of an access point select screen 62. The access point select screen 62 is displayed, for example, when the “Wireless LAN communication” has been selected on the communication system select screen 61. The access point select screen 62 includes items which are indicative of access points (SSID) which are connectable at the present position. The access point select screen 62 includes, for example, an “Access point A” button 62A, an “Access point B” button 62B, an “Access point C” button 62C, and an “Access point D” button 62D. Using the access point select screen 62, the user selects a button corresponding to the access point that is to be connected at the present position.

The select screen display module 44 outputs to the communication system switching module 43 the information indicative of the wireless communication system which has been selected by using the communication system select screen 61. As in the case of the communication system switching mode, the communication system switching module 43 effects switching to the selected wireless communication system. For example, when the wireless LAN communication has been selected and also the access point has been selected, the communication system switching module 43 executes control to connect the wireless LAN communication module 122 to the selected access point (e.g. the communication system switching module 43 outputs to the wireless LAN communication module 122 a signal which requests the wireless LAN communication module 122 to establish a connection to the selected access point).

In addition, the select screen display module 44 outputs to the communication system storing module 45 the position information indicative of the present position and the information indicative of the wireless communication system which has been selected by using the communication system select screen 61. Responding to the output by the select screen display module 44, the communication system storing module 45 generates a new entry indicative of the present position and the selected single wireless communication system, and adds the new entry to the communication system select information 109A. To be more specific, the communication system storing module 45 generates a new entry indicative of the latitude and longitude of a representative point corresponding to the present position and the selected wireless communication system, and adds the new entry to the communication system select information 109A. The relationship between the present position and the position (representative point) indicated in the entry of the communication system select information 109A has already been described with reference to FIG. 8.

The communication system storing module 45 may store in the HDD 109 an entry which further includes an SSID and an encryption key which correspond to the access point selected by using the access point select screen 62.

By the above-described structure, the communication system control program 202 can execute communication by the wireless communication system which is suited to the place of use. At a position where the wireless communication system has once been learnt, the communication system control program 202 can effect seamless switching to the wireless communication system corresponding to the user's selection (preference).

In addition, in the present embodiment, the communication system select information 109A, which indicates the correspondence between the position and the wireless communication system, is stored in the computer 10 (client). Thus, there is no need to provide a server for executing a process for switching the wireless communication system in accordance with the present position and for storing data, etc. necessary for this process. Therefore, the seamless switching to the wireless communication system corresponding to the present position can be realized at low cost.

A plurality of entries included in the communication system select information 109A may be prepared (stored) in advance in consideration of, for example, the area of activities of the user. Besides, each time the user visits a new place, an entry corresponding to the position of the place may be added. As regards a place to which the user may visit only once, as in a trip, the entry of the communication system select information 109A may not be created. In other words, the communication system control program 202 may be controlled so as not to operate in the communication system learning mode. Thereby, only the communication system select information 109A corresponding to the places (positions) which are necessary for the user can be created, and an increase of unnecessary data can be prevented.

Based on the history of selection of one wireless communication system from among a plurality of wireless communication systems at the present position (communication place), the communication system storing module 45 may associate the most frequently selected wireless communication system with the present position. In this case, even if the wireless communication system, which is used at the present position, has already been designated, the select screen display module 44 displays the communication system select screen 61. For example, when a request for changing the wireless communication system has been issued by the user, when a predetermined period has passed since the previous selection of the wireless communication system, or when the number of times of selection by the user of the wireless communication system at the present position is less than a predetermined number, the select screen display module 44 displays the communication system select screen 61. In addition, each entry of the communication system select information 109A includes information indicative of the number of times of selection of each of the plural wireless communication systems. For example, the entry corresponding to a certain position (communication place) includes the information indicative of the number of times of selection of the wireless LAN communication at this position, and the information indicative of the number of times of selection of the 3G communication at this position.

When one wireless communication system has been selected by using the communication system select screen 61, the select screen display module 44 outputs the position information indicative of the present position and the information indicative of the selected wireless communication system to the communication system storing module 45. Using the output by the select screen display module 44, the communication system storing module 45 updates the entry of the communication system select information 109A, which corresponds to the present position. Specifically, the communication system storing module 45 increments the number of times, which corresponds to the selected wireless communication system, by one in the entry of the communication system select information 109A, which corresponds to the present position. For example, when “Wireless LAN communication” has been selected by using the communication system select screen 61, the communication system storing module 45 increments the number of times of “Wireless LAN communication” by one in the entry of the communication system select information 109A, which corresponds to the present position.

Subsequently, the communication system storing module 45 associates the most frequently selected wireless communication system of all the plural wireless communication systems with the present position for the entry of the communication system select information 109A which corresponds to the present position. Specifically, the communication system storing module 45 sets the most frequently selected wireless communication system in the “Communication system” of the entry. For example, when the “3G communication” is most frequently selected at the present position (i.e. when the number of times of “3G communication” in the entry is greater than the number of times of other wireless communication systems), the communication system storing module 45 sets the “3G communication” in the “Communication system” of the entry corresponding to the present position. The communication system switching module 43 switches to the wireless communication system set in “Communication system” of the entry corresponding to the present position.

Thereby, it is possible to add (store) the entry indicative of the present position and the most frequently selected wireless communication system in the communication system select information 109A based on the history of selection by the user of one wireless communication system from among a plurality of wireless communication systems. Since the wireless communication system, which is to be associated with the present position, is determined based on the history of selection by the user, wireless communication can be executed by the wireless communication system determined in consideration of the user's preference.

In the meantime, the communication system control program 202 may switch the wireless communication system, taking into account the height as well as the position. In this case, the communication system select information 109A is stored in the HDD 109. The communication system select information 109A indicates the position, the height, and one wireless communication system of a plurality of wireless communication systems. The one wireless communication system is associated with the position and height. In addition, the position detection module 41 detects the present position and present height of the computer 10. When the entry corresponding to the detected present position and present height is included in the communication system select information 109A, the communication system switching module 43 executes communication by the wireless communication system indicated in the entry. On the other hand, when the entry corresponding to the detected present position and present height is not included in the communication system select information 109A, the communication system switching module 43 executes communication by one wireless communication system which is selected from among the plural wireless communication systems. This one wireless communication system is selected by the user, for example, by using the communication system select screen 61.

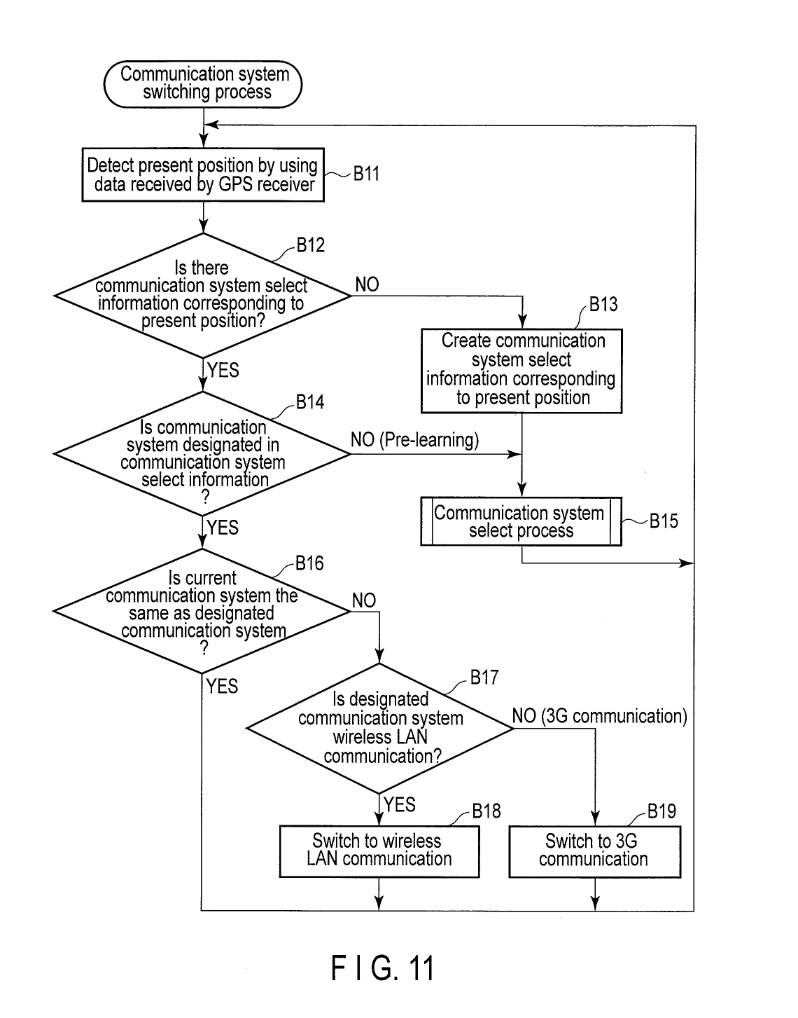

Next, referring to a flowchart of FIG. 11, a description is given of an example of the procedure of a communication system switching process executed by the computer 10. In the description below, it is assumed that either wireless LAN communication or 3G communication is used as the wireless communication system.

To start with, the position detection module 41 detects the present position of the computer 10 using the data received by the GPS receiver 111 (block B11). Then, the mode determination module 42 determines whether an entry corresponding to the present position (i.e. an entry of a communication place corresponding to the present position) is included in the communication system select information 109A based on the present position detected by the position detection module 41 (block B12).

When the entry corresponding to the present position is not included in the communication system select information 109A (NO in block B12), the mode determination module 42 generates an entry of the communication system select information 109A, which corresponds to the present position (block B13).

When the entry corresponding to the present position is included in the communication system select information 109A (YES in block B12), the mode determination module 42 determines whether the wireless communication system is designated in the entry corresponding to the present position (block B14). Specifically, the mode determination module 42 determines whether one of a plurality of wireless communication systems has already been associated with the present position.

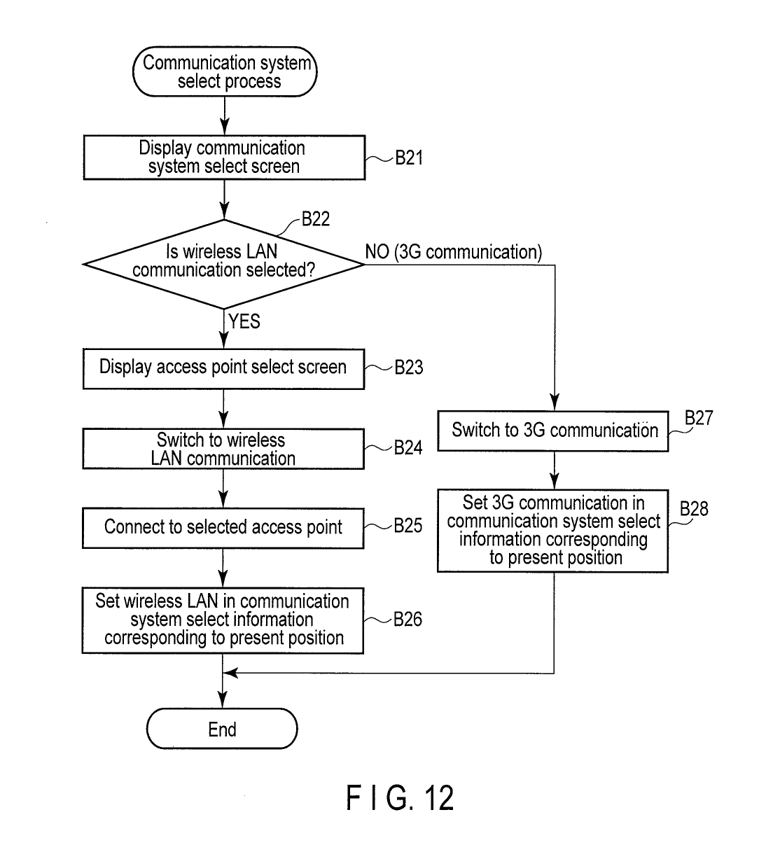

When the wireless communication system is not designated in the entry corresponding to the present position (NO in block B14), or after the entry of the communication system select information 109A, which corresponds to the present position, has been generated in block B13, the select screen display module 44 and communication system storing module 45 execute a communication system select process (block B15). The procedure of the communication system select process will be described later with reference to a flowchart of FIG. 12.

When the wireless communication system is designated in the entry corresponding to the present position (YES in block B14), the communication system switching module 43 determines whether the currently used wireless communication system is the same as the designated wireless communication system (block B16). When the currently used wireless communication system is the same as the designated wireless communication system (YES in block B16), the process goes back to block B11. That is, the wireless communication by the currently used wireless communication system is continuously executed.

When the currently used wireless communication system is not the same as the designated wireless communication system (NO in block B16), the communication system switching module 43 determines whether the designated wireless communication system is wireless LAN (block B17). When the designated wireless communication system is wireless LAN (YES in block B17), the communication system switching module 43 effects switching so that wireless communication is executed by using the wireless LAN communication module 122 (block B18). On the other hand, when the designated wireless communication system is not wireless LAN (NO in block B17), the communication system switching module 43 effects switching so that wireless communication is executed by using the 3G communication module 121 (block B19).

FIG. 12 is a flowchart illustrating an example of the procedure of a communication system select process which is executed by the computer 10. The communication system select process is executed, for example, when an entry of the communication system select information 109A, which corresponds to the present position, is not generated, or when a communication system is not designated in the entry of the communication system select information 109A, which corresponds to the present position.

To start with, the select screen display module 44 displays the communication system select screen 61 on the screen of the LCD 17 (block B21). The communication system select screen includes a plurality of items indicative of a plurality of wireless communication systems. The user selects an item corresponding to a wireless communication system which is to be used at the present position from among the plurality of items.

Then, the select screen display module 44 determines whether “Wireless LAN communication” has been selected by using the communication system select screen 61 (block B22). When “Wireless LAN communication” has been selected (YES in block B22), the select screen display module 44 displays the access point select screen 62 (block B23). The access point select screen 62 includes a list of connectable access points (e.g. SSID). The user selects an access point which is to be connected at the present position from the list.

The communication system switching module 43 effects switching so that wireless communication may be executed by using the wireless LAN communication module 122 (block B24). Then, the communication system switching module 43 establishes a connection between the wireless LAN communication module 122 and the access point selected by using the access point select screen 62 (block B25). Subsequently, the communication system storing module 45 sets “Wireless LAN communication” in the entry of the communication system select information 109A, which corresponds to the present position (communication place) (block B26).

When “Wireless LAN communication” has not been selected (NO in block B22), that is, when “3G communication” has been selected, the communication system switching module 43 effects switching so that wireless communication may be executed by using the 3G communication module 121 (block B27). Then, the communication system storing module 45 sets “3G communication” in the entry of the communication system select information 109A, which corresponds to the present position (block B28).

As has been described above, according to the present embodiment, communication can be executed by the wireless communication system which is suited to the place of use. For example, using the position information indicative of the present position of the computer 10 and the communication system select information 109A that is stored in the HDD 109, the communication system control program 202 controls the wireless communication module so that the communication may be executed by the wireless communication system associated with the present position. When the communication system select information 109A corresponding to the present position is not stored in the HDD 109, the communication system control program 202 controls the wireless communication module so that the communication may be executed by one wireless communication system which is selected from among a plurality of wireless communication systems. Then, the communication system select information 109A including the present position and the selected wireless communication system is newly stored in the HDD 109. Thereby, at a position where the wireless communication system has once been learnt, seamless switching can be effected to the wireless communication system corresponding to the user's selection (preference).

All the procedures of the communication system switching process and communication system select process of this embodiment may be executed by software. Thus, the same advantageous effects as with the present embodiment can easily be obtained simply by installing a computer program, which executes the procedures of the communication system switching process and communication system select process, into an ordinary computer through a computer-readable storage medium, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a wireless communication module configured to execute wireless communication with a plurality of wireless communication systems;
an information module configured to process
first system information relating to a first wireless communication system, and
first position information relating to a position associated with the first wireless communication system;
a position detector configured to detect a present position of the electronic apparatus; and
a selector configured to
select the first wireless communication system when the present position corresponds with the first position information, and
allow a user to select a second wireless communication system when the present position does not correspond to the first position information,
wherein the information module is further configured to process
second system information relating to the second wireless communication system, and
second position information relating to the present position.

2. The electronic apparatus of claim 1, further comprising
a display configured to display one or more items corresponding to one or more of the plurality of wireless communication systems when the present position does not correspond to the first position information, and
an interface configured to receive a user selection of one of the items, and wherein the second wireless communication system corresponds to the user selection.

3. The electronic apparatus of claim 2, wherein the information module is configured to process
additional system information relating to a wireless communication system corresponding to a most frequent user selection, based on a history of selection of one of the items by the user, and
additional position information relating to the present position.

4. The electronic apparatus of claim 1, wherein
the information module is further configured to process first height information relating to a height associated with the first wireless communication system, the position detector is further configured to detect a present height of the electronic apparatus,
the selector is further configured to
select the first wireless communication system when both the present position corresponds with the first position information and the present height corresponds with the first height information, and
allow the user to select the second wireless communication system when the present position does not correspond with the first position information and/or the present height information does not correspond with the first height information, and
the information module is further configured to process second height information relating to the present height.

5. The electronic apparatus of claim 1, wherein the plurality of wireless communication systems comprises
a communication system based on IEEE 802.11 standards, and
a mobile communication system.

6. The electronic apparatus of claim 5, wherein the plurality of wireless communication systems comprises a communication system based on IEEE 802.16e standards.
